(19) United States
(12) Patent Application Publication
(10) Pub. No.: US 2009/0073313 A1
(43) Pub. Date: Mar. 19, 2009

(54) Method for Controlling a Television

(75) Inventor: Kai Min Liu, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/855,599

(22) Filed: Sep. 14, 2007

(51) Int. Cl. H04N 7/00

(52) U.S. Cl. 348/468; 348/E07.001

(57) ABSTRACT

A method for controlling a television equipped with a camera sensor is performed as follows. A background image is captured by the camera sensor. After entering a control mode, functional blocks are displayed on the television, and a user image is captured by the camera sensor and shown on the television. A control command is based on the user image, the functional block and the background image, and the television is controlled by the control command. Accordingly, the control functions of the traditional remote controller can be replaced by analysis and comparison of the user image and the background image, and therefore, it is more convenient for the user if the remote controller is absent.

### BACKGROUND OF THE INVENTION

(A) Field of the Invention

The present invention is related to a method for controlling, and more specifically, to a method for controlling a television (TV).

(B) Description of Related Art

As shown in FIG. 1, for a traditional TV system 10, an infrared (IR) remote controller 11 is needed to switch or adjust functions such as channel, source, Picture in Picture (PIP), volume, brightness and contrast of the panel 14. When the user presses a button on the remote controller 11, the corresponding signal is transmitted to and received by an IR receiver 12. Then, the signal is processed by a system board 13 to generate a corresponding control command for controlling the TV system 10.

However, if the IR remote controller 11 is missing, it is inconvenient for the user to control the TV. Moreover, some display factors such as brightness and color cannot be adjusted automatically, and it would not be comfortable for the human eye if these display factors were not properly adjusted.

### SUMMARY OF THE INVENTION

The present invention discloses a method for controlling a digital TV with a camera sensor in an attempt to provide various control ways by means of capturing images from the camera sensor. The TV of the present invention can be controlled by the user without a remote controller, and the TV factors such as brightness or color can adjusted in response to the environment automatically.

In accordance with a first embodiment of the present invention, a method for controlling a television equipped with a camera sensor is performed as follows. A background image is captured by the camera sensor. After entering a control mode, functional blocks are displayed on the television, and a user image is captured by the camera sensor and shown on the television. A control command is determined, based on the user image, the functional block and the background image, and the television is controlled by the control command. Accordingly, the control commands generated by the traditional remote controller can be replaced by analysis and comparison of the user image, the functional block and the background image; therefore, it is more convenient for the user given that the remote controller is absent.

In accordance with a second embodiment of the present invention, a method for controlling a television equipped with a camera sensor is performed as follows. An environmental factor is detected by the camera sensor, and a relation between a television factor with different levels and the environmental factor with different levels is established. The television factor is adjusted to be suitable for the user based on the environmental factor. The television factor is automatically controlled in response to the current level of the environmental factor according to the relation. For example, the television factor is brightness and the environment factor is lightness, or the television factor is display color and the environmental factor is environmental color. Consequently, the brightness and color of the TV can be automatically adjusted in response to the lightness and color of the background image.

### BRIEF DESCRIPTION OF THE DRAWINGS

FIG. 1 shows a traditional TV system;

FIG. 2(a) shows the TV system used for the present invention;

FIG. 2(b) shows an embodiment of a user image of the present invention;

FIG. 3 shows an embodiment of functional blocks of the present invention;

FIG. 4 is a flow chart showing an embodiment of the method for controlling a television of the present invention;

FIG. 5 shows an embodiment of the TV power-saving method of the present invention; and

FIG. 6 is a flow chart showing another embodiment of the method for controlling a television of the present invention.

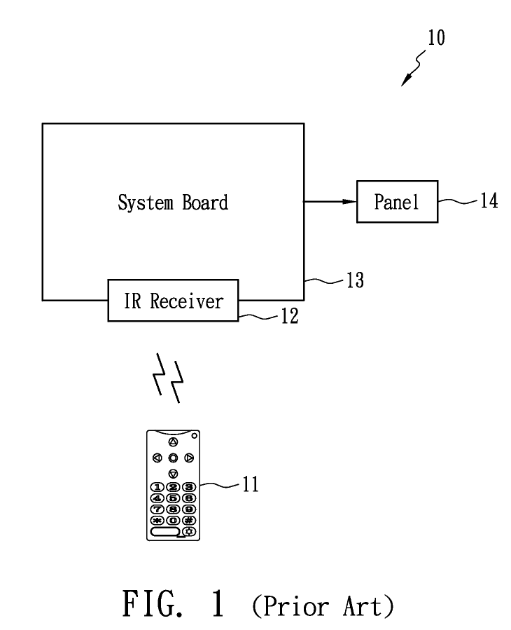

### DETAILED DESCRIPTION OF THE INVENTION

Camera Sensor Remote Controller

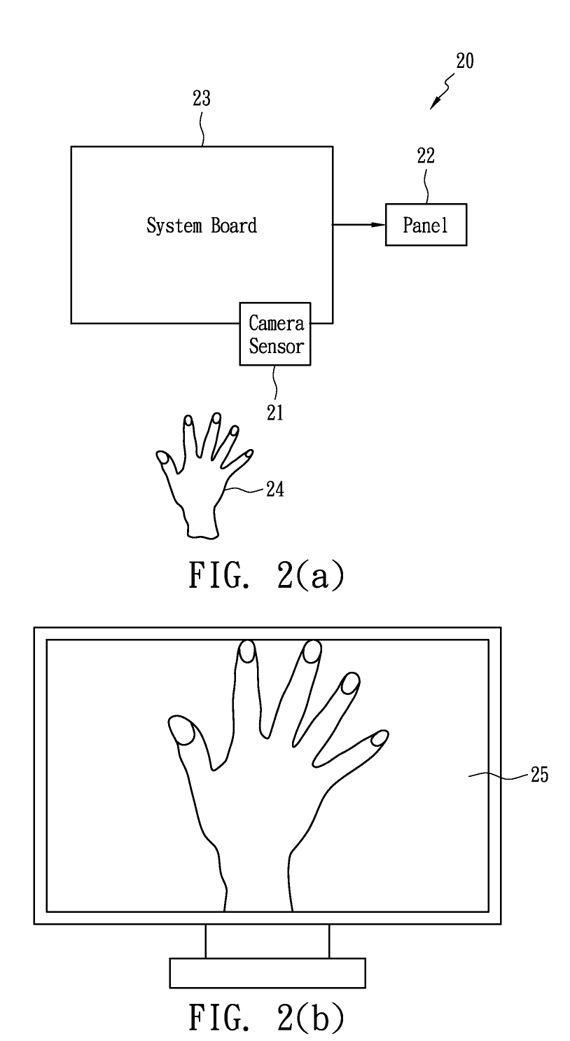

As shown in FIGS. 2(a) and 2(b), a television (TV) 20 is equipped with a camera sensor 21 through a USB or other interface. When utilizing the camera sensor 21 for remote control initially, the camera sensor 21 captures an image, and then the image is displayed on a screen 25 of the panel 22 through a system board 23. Then the camera sensor 21 is adjusted for a suitable view angle, for example, a user can raise a hand, and the image of the hand 24 is displayed at the upper region of the screen 25.

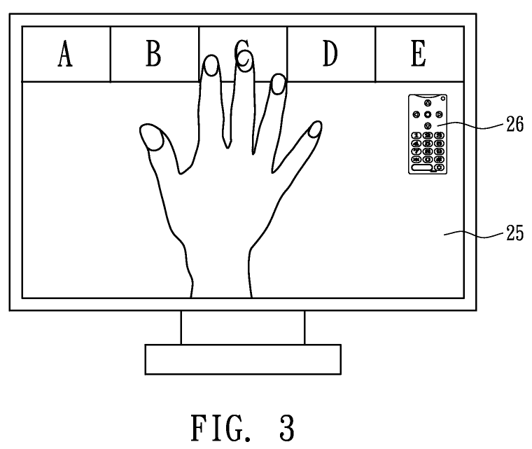

As shown in FIG. 3, in this embodiment, the upper region of the screen 25 is separated into five regions, A, B, C, D and E, and each region can be defined as a functional block corresponding to different functions, e.g., channel up/down, PIP enable/disable, power on/off and volume. The camera sensor 21 captures a background image first. Next, the user raises a hand to cover one of the regions, which is captured by the camera sensor 21 and displayed on the panel 22. The images may be stored in a memory such as a flash memory or an EEPROM. For example, if a user raised a hand in region C corresponding to a function of “POWER OFF”, the currently captured image is compared with the previously captured background image. If the region C in the currently captured image and the region C in the background image are substantially different, it is recognized as activating the function of “POWER OFF”, and then the TV 20 is controlled to be powered off. Alternatively, the substantial difference between the currently captured image and the background image is further determined based on a time duration. That is, the region C in the currently captured image and the region C in the background image are considered substantially different if the user's hand covers the region C for a few seconds.

Instead of recording the whole background image, only environmental characteristic data (R/G/B/Y/U/V) in the regions may be recorded. The number of regions (functional blocks) is preferably equal to the number of required control functions. The size of the functional block is adjustable in response to the image size of the user's hand. The farther away the smaller hand is, the smaller the functional block should be.

In the case of three functional blocks, one is PIP enable/disable, one is channel up, and one is channel down. For example, when the user raises his or her hand in the channel-up region, the channel will go up. Moreover, an image of “a remote controller” 26 can be drawn on an OSD (On Screen Display) layer, and overlapped (alpha-blending) with the user image. For two display layers with alpha blending (maybe 50%), one layer is a picture of a push button, and the other layer is the user's hand image, so the user can see and control his or her hand in order to push a button of the “remote controller” on the screen. Therefore, the user's hand can control the “remote controller” on the TV screen.

Consequently, the user can enter a control mode to determine a control command based on the user image, the functional block and the background image.

Given the fact that an IR remote controller is missing, the user still can control the TV. Normally, the functional blocks are above the user's head in the screen, and the “ON” and “OFF” states have to be maintained for a few seconds to avoid erroneous indications.

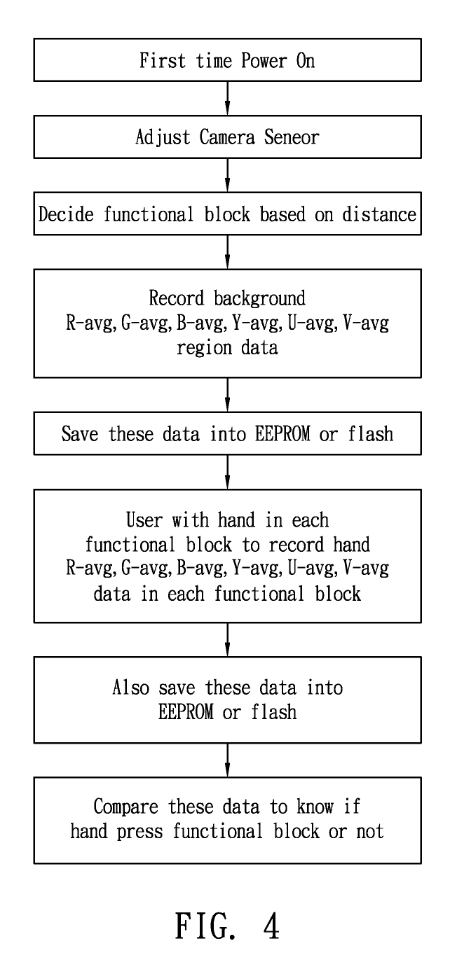

FIG. 4 shows a flow chart of the method of the present invention. After the TV is powered on, a camera sensor is adjusted in response to the location of the user. Functional blocks on the television screen are then determined, and the size of the functional block, e.g., 5×10 pixels, is based on the distance between the TV and the user, so that a hand can fit in the functional block like pushing a button. Then, environmental background such as R-avg, G-avg, B-avg, Y-avg, U-avg and V-avg data are recorded and saved into an EEPROM or a flash, where R, G, and B represent red color, green color and blue color respectively; Y represents luminance; U and V represent two chrominance indexes; “avg” represents the average value. The user moves a hand in each region to record R-avg, G-avg, B-avg, Y-avg, U-avg and V-avg again, and the user indication data are saved in the EEPROM or the flash as well. The background data and the user indication are compared to verify whether the hand enables an operation, e.g., pressing a functional block.

Dynamic Brightness Adjustment

The camera sensor can detect lightness data of environment and the detected lightness data is then recorded in a flash memory or an EEPROM, so that a user can adjust the brightness level of the TV in response to different lightness conditions. Afterwards, the user can turn on the dynamic brightness adjustment function based on the recorded data, and the TV will be set to a correct brightness in response to the current lightness of the environment. If the user does not set the brightness level, the TV will use its default level setting in different conditions.

For example, in the outdoors, the brightness of a TV display can be automatically adjusted depending on weather, day or night. If the TV is in a kitchen, bathroom or meeting room, it may be not convenient to adjust the brightness of TV by hand. Therefore, the method of the present invention can automatically adjust the brightness in response to the lightness, so that the display will be clearer and suitable for human eyes.

Dynamic Color Adjustment

The camera sensor detects environmental colors and the detected data is recorded in a flash memory or an EEPROM. The user can adjust the color level in response to different color conditions. The TV display color (SRGB or hue/saturation) depends on the camera sensor data. In other words, the user can turn on the dynamic color adjustment function based on the recorded data, and the TV will be set to a correct color in response to the current color of the environment. Normally, there is a default color setting in different conditions. The user can decide to enable or disable this function.

For example, if the camera detects that the environment has a red color base, it will adjust the TV display to intensify the red color to match the entire environment. Likewise, if the camera detects that the environment has a blue color base, it will adjust the TV display to intensify blue color.

TV Power Saving

The user can press a button to enable the power-saving function. The camera sensor will detect motion in the environment (pixel by pixel). If there is no object in motion in this environment for a period, e.g., a few minutes, the TV screen will turn off automatically. If a user goes to sleep or leaves, no object in motion is detected, so the TV will turn off automatically. For example, the blink of eyes is deemed an object in motion, and would not cause the TV screen to turn off. A frame buffer is needed to detect the motion condition. The motion detection can select Y/U/V or R/G/B domains.

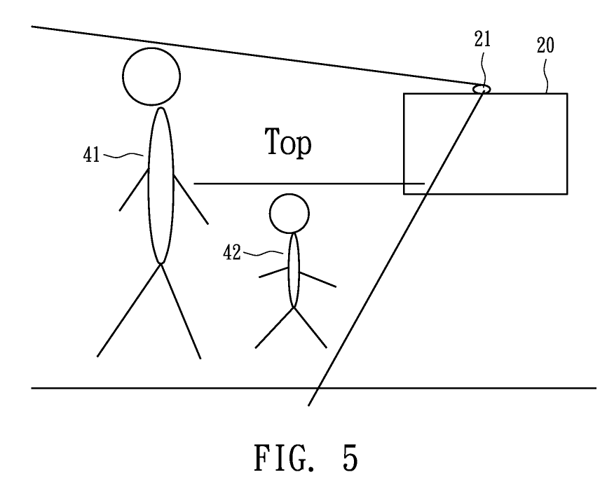

FIG. 5 shows an adult 41 and a child 42 watching the television 20. If the child casually moves toward the television 20, the television 20 should be automatically turned off due to safety concerns. Therefore, an automatically power-saving mechanism is established accordingly. Normally, the child 42 is shorter than the adult 41, and the camera sensor 21 can detect whether the motion only occurs below a “Top” region of the capturing region of the camera sensor 21. If a motion is detected below the “Top” region, the motion will be deemed an approach of the child 41, and the television 20 will turn off. The determination of the “motion” can be related to the number of pixels of the “motion.” When a body (e.g., a child) is close to the television, the number of pixels of the body will increase. If the child 42 approaches the television 20, the television screen will turn off for a few minutes. Further, when the child 42 gets away from the television 20 for a few minutes, the television 20 may turn on automatically. A detection mechanism for an adult or a child is proposed below.

Child's approaching motion: The number of motion pixels below “Top” region is greater than a first threshold value (threshold 1) and the number of motion pixels in the “Top” region is smaller than a second threshold value (threshold 2).

Adult's approaching motion: The number of motion pixels of the “Top” region is greater than the second threshold value (threshold 2).

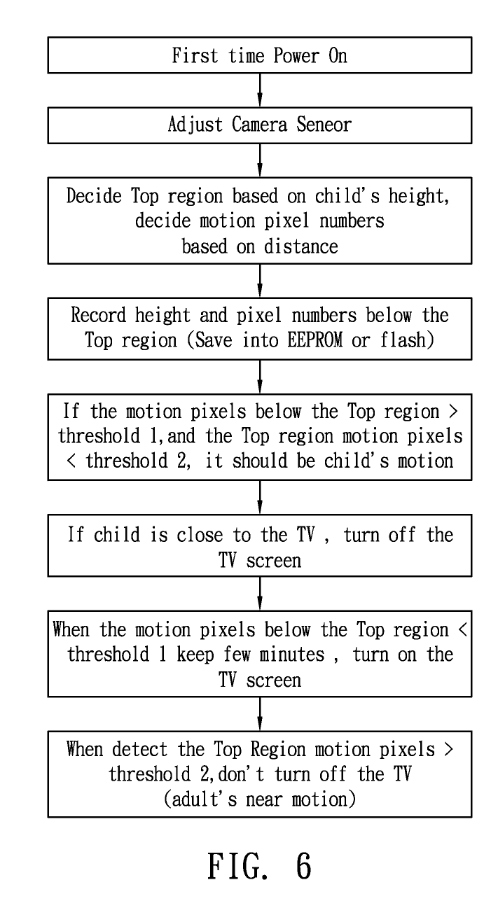

FIG. 6 is a flow chart showing an embodiment of the power-saving procedures of the present invention. After the power is on, the camera sensor is adjusted to aim at the user for image capturing. A “Top” region is based on a child's height, and the number of motion pixels is based on distance between a user and the television. The height and the number of motion pixels below the “Top” region are recorded and saved in a memory such as an EEPROM or a flash. If the number of motion pixels below the “Top” region is larger than a first threshold value (threshold 1) and the number of motion pixels in the “Top” region is smaller than a second threshold value (threshold 2), it would be deemed an approach of a child to the television. Subsequently, the television will turn off. When the number of motion pixels below the “Top” region is smaller than the first threshold value (threshold 1) for a few minutes, it would be deemed that the child is away from the television, so the television screen will be turned on. Moreover, if the number of motion pixels in the “Top” region is larger than the second threshold value (threshold 2), it would be deemed an approach of an adult.

In summary, the LCD TV with a camera sensor embedded can have the following functions:
1. When the TV remote controller is missing, the user still can switch or adjust the channel, power source, PIP, volume, brightness or contrast by hand.
2. When a user is busy or it is inconvenient to adjust the brightness, the display brightness of the TV will be adjusted automatically in response to the lightness of the environment.
3. The display color is dynamically adjusted in response to the color of the environment.
4. Power saving: Detect motion image (blinking of eyes is also deemed an object in motion). If there is no object in motion, the TV screen will turn off automatically.

Accordingly, a digital TV with a camera sensor can provide various control functions by capturing images from the camera sensor. In addition to the TV being controlled by the user without a remote controller, the TV factors such as brightness or color can adjusted in response to the environment automatically.

The above-described embodiments of the present invention are intended to be illustrative only. Numerous alternative embodiments may be devised by those skilled in the art without departing from the scope of the following claims.

What is claimed is:

1. A method for controlling a television equipped with a camera sensor, comprising:
capturing a background image by the camera sensor;
entering a control mode;
displaying functional blocks on the television;
capturing a user image by the camera sensor and showing the user image on the television;
determining a control command based on the user image, the functional block and the background image; and
controlling the television by the control command.

2. The method in accordance with claim 1, wherein the control command determining step comprises:
determining a user indication by comparing the user image with the background image; and
determining the control command by comparing the user indication with the functional blocks.

3. The method in accordance with claim 2, wherein the user indication is determined by comparing the image of the user's hand with the background image.

4. The method in accordance with claim 1, wherein the functional blocks correspond to different control commands.

5. The method in accordance with claim 4, wherein the number of the functional blocks is equal to the number of the control commands.

6. The method in accordance with claim 1, wherein the functional blocks are on an upper region of the screen of the television.

7. The method in accordance with claim 1, wherein the size of the functional block is in response to a distance between the user and the television.

8. The method in accordance with claim 1, wherein the control command is selected from the group consisting of power on/off, channel up/down, Picture in Picture (PIP) enable/disable and volume up/down.

9. The method in accordance with claim 1, wherein a remote controller image is shown in an on screen display (OSD) layer of the television so that the user can control the television with the control command.

10. The method in accordance with claim 1, wherein the television turns off if the user image shows no object in motion for a predetermined period.

11. The method in accordance with claim 1, wherein the television turns off if the user image shows that an object in motion is below a top region of a capturing region of the camera sensor.

12. The method in accordance with claim 11, wherein the object in motion below the top region of a capturing region of the camera sensor is determined if the pixel number of the object in motion below the top region is larger than a first threshold value and the pixel number of the top region is smaller than a second threshold value.

13. A method for controlling a television equipped with a camera sensor, comprising:
detecting an environmental factor by the camera sensor;
establishing a relation between a television factor of the television with different levels and the environmental factor with different levels by a user, wherein the television factor is adjusted to be suitable for the user based on the environmental factor; and
automatically controlling the television factor in response to current level of the environmental factor according to the relation.

14. The method in accordance with claim 13, wherein the television factor is brightness and the environment factor is lightness.

15. The method in accordance with claim 13, wherein the television factor is display color and the environmental factor is environmental color.

16. The method in accordance with claim 13, wherein the environmental factor is derived from a background image captured by the camera sensor.
